(19) United States
(12) Patent Application Publication
(10) Pub. No.: US 2012/0206277 A1
(43) Pub. Date: Aug. 16, 2012

(54) SOLAR-POWERED PORTABLE ENERGY-SAVING LIGHT-EMITTING TRAFFIC SIGN

(75) Inventor: Shuei-Tian CAI, Taichung City (TW)

(73) Assignee: SAFETY TRAFFIC EQUIPMENT CO., LTD., Taichung City (TW)

(21) Appl. No.: 13/026,409

(22) Filed: Feb. 14, 2011

(51) Int. Cl. G08G 1/00

(52) U.S. Cl. 340/928

(57) ABSTRACT

A solar-powered portable energy-saving light-emitting traffic sign has a main body, with its traffic sign surface provided with LED luminous bodies. A solar energy device is assembled onto the support bar of the main body, and has a photovoltaic panel and rack. A battery is assembled onto the support bar. A starting switch enables activation and manual highlighting of LED bodies on the traffic sign. A timer is assembled onto the support bar to set and control auto-off time of the LED bodies. A wireless transmitter for synchronous transmission control, is assembled onto the support, and composed of a wireless transmitting module and a wireless receiving module. The wireless transmitting module is activated by the starting switch to transmit a wireless starting signal. The receiving module is normally opened. When the wireless receiving module receives the starting signal, the LED bodies can also be highlighted.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a portable energy-saving light-emitting traffic sign powered by solar energy, and more particularly to an innovative one which allows users to start it manually, switch off regularly, or activate and control multiple sets simultaneously to reduce the configuration cost and realize better energy conservation effect in the traffic environment of low utilization rate.

2. Description of Related Art Including Information Disclosed Under 37 CFR 1.97 and 37 CFR 1.98

In the modern society with a well-developed traffic system, the traffic marks and symbols (collectively referred to as traffic signs) play a vital role at the crossroad and roadside for traffic warning, guidance and marking, etc.

In addition to signal lamps already fitted with a luminous body, the other marks with only graphical representations are also equipped with a luminous body for satisfactory identification in the case of poor visibility or in the nighttime, thus leading to bigger power consumption.

To provide power for the luminous body on the traffic signs, it is imperative to deploy an electric circuit. Despite of the benefits and necessity of electric circuit for the traffic signs of higher utilization rate in urban regions, the problem of resource waste still remains unsolved.

For the traffic signs of low utilization rate, such as traffic symbols in remote crossroads, project exits and hilly areas, the deployment of electric circuit for power supply and synchronous operation lacks of actual economic benefits.

Notwithstanding traffic signs with solar energy unit are already developed, such mechanisms are generally provided with a timer or optical sensor for switching control. In the environment of low utilization rate, there is still a room for improvement due to the shortcoming of bigger power consumption.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique configuration of the present invention wherein “the solar-powered portable energy-saving light-emitting traffic sign” mainly comprises said main body, solar energy device, battery, starting switch, timer and wireless transmitter, the traffic sign enables to start it manually, switch off regularly, or activate and control multiple sets simultaneously to reduce the configuration cost and realize better energy conservation effect in the traffic environment of low utilization rate, particularly in remote crossroads, project exits and hilly areas.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the preferred embodiment of the present invention.

FIG. 2 is another perspective view with light-emitting from a single traffic sign of the present invention.

FIG. 3 is a schematic view of a plurality of traffic signs of the present invention.

FIG. 4 is another schematic view of a plurality of traffic signs of the present invention.

### DETAILED DESCRIPTION OF THE INVENTION

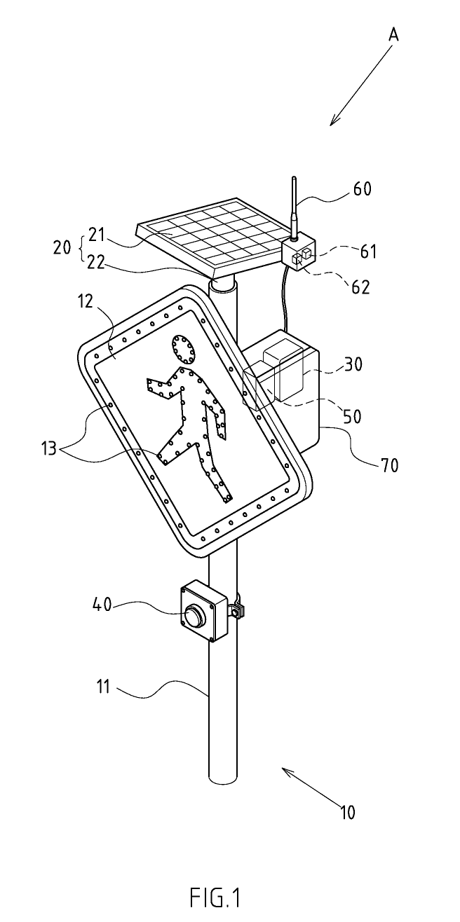

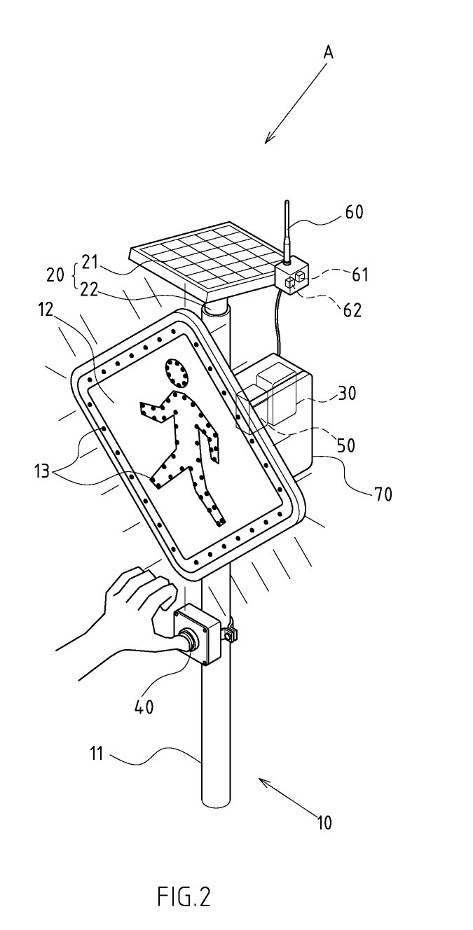

FIGS. 1-2 depict preferred embodiments of a solar-powered portable energy-saving light-emitting traffic sign of the present invention, which, however, are provided for only explanatory objective for patent claims.

The traffic sign A includes at least a main body 10, having a support bar 11 and a traffic sign surface 12 positioned on the support bar 11. The traffic sign surface 12 is provided with LED luminous bodies 13 generating light-emitting effects. The support bar 11 is available with a single bar or multiple bars.

A solar energy device 20 is assembled onto the support bar 11 of the main body 10 (preferably onto the top), and composed of a photovoltaic panel 21 and a rack 22. Of which, the rack 22 is used to mount the photovoltaic panel 21 onto the support bar 11, and said rack 22 is configured into a fixed or adjustable pattern.

A battery 30 is assembled onto the support bar 11 of the main body 10 and electrically connected with the photovoltaic panel 21, so as to store the electric energy generated by the photovoltaic panel 21.

A starting switch 40 is assembled onto the support bar 11 of the main body 10 enabling easy access for manual control. This starting switch 40 enables the users to activate and highlight manually LED luminous bodies 13 on the traffic sign surface 12.

A timer 50 is assembled onto the support bar 11 of the main body 10, and used to set and control auto-off time of the LED luminous bodies 13.

A wireless transmitter 60 for synchronous transmission control is assembled onto the support bar 11 of the main body 10, and composed of a wireless transmitting module 61 and a wireless receiving module 62. Of which, the wireless transmitting module 61 is activated by the starting switch 40 to transmit a wireless starting signal.

Of which, the wireless receiving module 62 is normally opened. When the wireless receiving module 62 receives said wireless starting signal, the LED luminous bodies 13 on the traffic sign surface 12 can also be highlighted.

Hence, the traffic sign A powered by the solar energy allows to start it manually, switch off regularly, or activate and control multiple sets simultaneously to reduce the configuration cost and realize better energy conservation effect in the traffic environment of low utilization rate.

Of which, the traffic sign surface 12 of the main body 10 is provided with either graphic symbols (e.g.: caution! children or pedestrian, giving a warning to the drivers) or lamp signal (e.g.: traffic control signal, crosswalk signal).

Of which, the battery 30 and timer 50 can be combined and assembled into an electro-mechanical box 70, which is then mounted onto the support bar 11 of the main body 10, so as to shorten the assembly path of the circuit, reduce the exposure to external vandalism and weathering, and contribute to extend greatly the service life of the traffic sign.

Of which, the wireless transmitter 60 is mounted at either side of the photovoltaic panel 21.

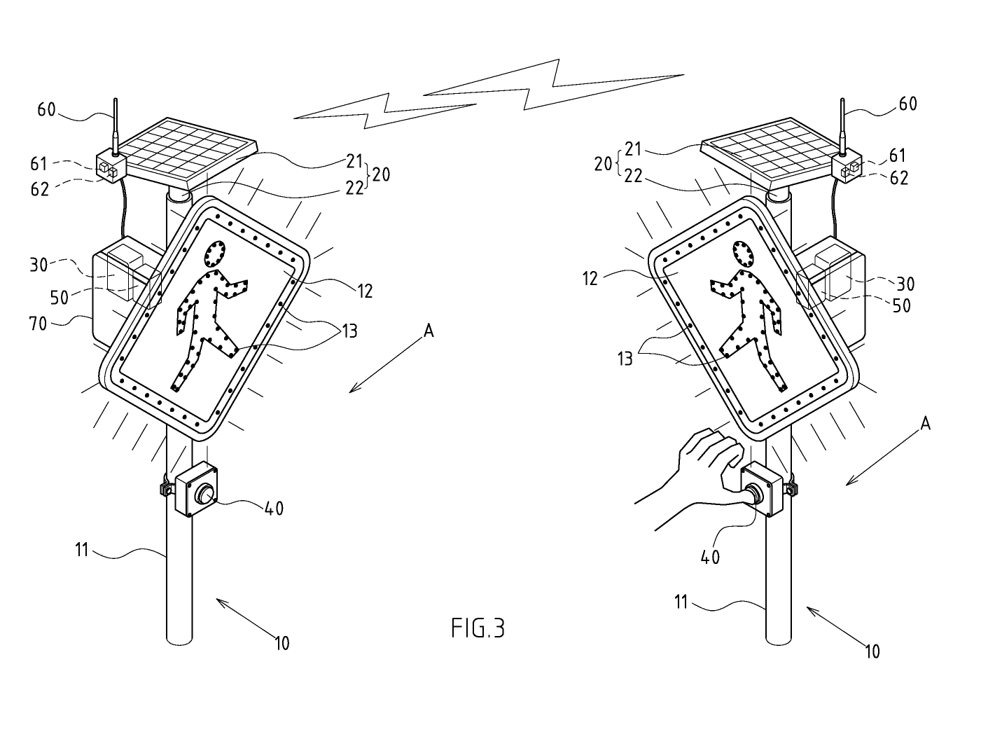

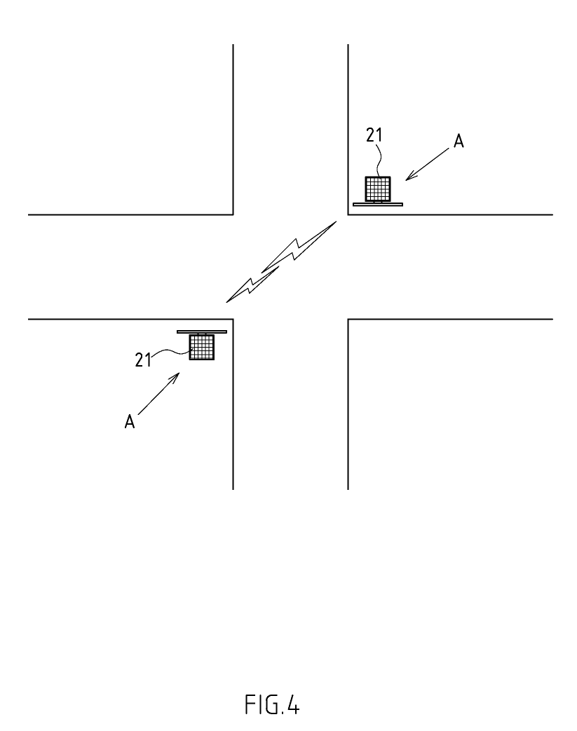

Based on above-specified structural configuration, the core of the traffic sign of the present invention lies in that, the main body 10 can be powered by the solar energy and started manually, and the photovoltaic panel 21 of the solar energy device 20 is used to convert the optical energy into electric energy, which is then stored into the battery 30 for highlighting the LED luminous bodies 13 on the traffic sign surface 12. When a single main body 10 is configured, the LED luminous bodies 13 of said main body 10 are highlighted by the starting switch 40 (disclosed in FIG. 2). When a plurality of main bodies 10 is configured, and the starting switch 40 on either of the main bodies 10 is started, the wireless transmitting module 61 is activated to transmit a wireless starting signal, and the wireless receiving module 62 on the remaining main bodies 10 receives said wireless starting signal to highlight the LED luminous bodies 13 on the traffic sign surface 12 of the main body 10 (disclosed in FIGS. 3, 4), thereby realizing synchronous wireless startup of multiple traffic signs. In such case, the traffic sign powered by the solar energy enables to start it manually, switch off regularly, or activate and control multiple sets simultaneously to reduce the configuration cost and realize better energy conservation effect in the traffic environment of low utilization rate. So, the traffic sign is particularly suitable for traffic symbols of low utilization rate, e.g.: in remote crossroads, project exits and hilly areas, helping to cut down the configuration cost and realize better energy conservation.

1. A solar-powered portable energy-saving light-emitting traffic sign, comprising:
at least a main body having a support bar and at least a traffic sign surface positioned on the support; the traffic sign surface is provided with LED luminous bodies generating light-emitting effects;
a solar energy device, assembled onto the support bar of the main body, and composed of a photovoltaic panel and a rack; of which the rack is used to mount the photovoltaic panel onto the support;
a battery, assembled onto the support bar of the main body and electrically connected with the photovoltaic panel, so as to store the electric energy generated by the photovoltaic panel;
a starting switch, assembled onto the support bar of the main body, enabling the users to activate and highlight manually LED luminous bodies on the traffic sign surface;
a timer, assembled onto the support bar of the main body, and used to set and control auto-off time of the LED luminous bodies;
a wireless transmitter for synchronous transmission control, assembled onto the support bar of the main body, and composed of a wireless transmitting module and a wireless receiving module; of which the wireless transmitting module is activated by the starting switch to transmit a wireless starting signal;
of which, the receiving module is normally opened; when the wireless receiving module receives the wireless starting signal, the LED luminous bodies on the traffic sign surface can also be highlighted;
hence, the traffic sign powered by the solar energy allows to start it manually, switch off regularly, or activate and control multiple sets simultaneously to reduce the configuration cost and realize better energy conservation effect in the traffic environment of low utilization rate.

2. The structure defined in claim 1, wherein if a plurality of main bodies is configured and the starting switch on either of the main bodies is started, the wireless transmitting module is activated to transmit a wireless starting signal, and the wireless receiving module on the remaining main bodies receives said wireless starting signal to highlight the LED luminous bodies on the traffic sign surface of the main body, thereby realizing synchronous wireless startup of multiple traffic signs.

3. The structure defined in claim, wherein the traffic sign surface of the main body is provided with either graphic symbols or lamp signal.

4. The structure defined in claim 1, wherein the battery and timer can be combined and assembled into an electromechanical box, which is then mounted onto the support bar of the main body.

5. The structure defined in claim 1, wherein said wireless transmitter is mounted at either side of the photovoltaic panel.
